(19) United States
(12) Patent Application Publication
(10) Pub. No.: US 2008/0188374 A1
(43) Pub. Date: Aug. 7, 2008

(54) In-Solution Microarray Assay

(75) Inventors: Chung-Hsuan Chen, Taipei (TW); Yu-Chuan Chien, Taipei City (TW)

Correspondence Address: OCCHIUTI ROHLICEK & TSAO, LLP, 10 FAWCETT STREET, CAMBRIDGE, MA, 02138, US

(73) Assignee: Academia Sinica, Taipei (TW)

(21) Appl. No.: 12/022,553

(22) Filed: Jan. 30, 2008

Related U.S. Application Data
(60) Provisional application No. 60/898,434, filed on Jan. 30, 2007.

(51) Int. Cl. C40B 20/00; C40B 60/10

(52) U.S. Cl. 506/2; 506/38

(57) ABSTRACT

This invention relates to a kit and a system for performing an in-solution microarray assay, and a method of carrying out this assay. The kit includes a plate having a number of wells in which a plurality of magnetic beads are placed. These magnetic beads are coated with different probes, wherein beads placed in each individual well are coated with identical probes.

### CROSS-REFERENCE TO RELATED APPLICATIONS

This application claims priority from U.S. Provisional Application 60/898,434, filed Jan. 30, 2007, the contents of which are hereby incorporated by reference in their entirety.

### TECHNICAL FIELD

The present invention relates to a method of performing in-solution microarray analysis using magnetic beads.

### BACKGROUND

DNA microarray has been broadly used for studying gene function and single nucleotide polymorphism (SNP). Protein microarray and other assays are also expected to be important tools in research and diagnosis.

A conventional microarray assay uses microchips on which probes, such as oligonucleotides, are immobilized. There are many different approaches to prepare these chips. For example, Affymetrix Inc. has successfully developed and commercialized photon-initiated nucleotide printing. Another approach is to modify the chemical structure of an oligonucleotide so that it can be immobilized onto a chip surface. UV cross-linking is another method for immobilizing oligonucleotides.

Most microarray hybridization processes have been performed on chip surfaces. Due to the geometric constraint, an on-surface hybridization reaction usually takes a long time (e.g., >10 hours) to complete. Also, because of its low specificity, on-surface hybridization is not an optimal assay for detecting single nucleotide polymorphism (SNP).

### SUMMARY

The present invention includes a method of performing a microarray assay in a solution using magnetic beads. Also within the scope of this invention is a kit and a system for performing this method.

In one aspect, this invention features a method of performing a microarray assay in a solution using magnetic beads. The method includes the following steps: (1) providing a plate having a number of wells; (2) dispersing in the wells magnetic beads on which different probes are attached, each well containing one or more magnetic beads to which identical probes are attached; (3) applying a magnetic force to immobilize the magnetic beads onto the bottoms of the wells; (4) adding to the wells a solution suspected of containing one or more target molecules; (5) removing the magnetic force to allow the target molecules, if any, to bind to the probes in the solution; (6) re-applying the magnetic force to re-immobilize the magnetic beads onto the bottoms of the wells; (7) washing the wells to remove free molecules; and (8) detecting a signal in any of the wells, said signal indicating binding of one of the target molecules to one of the probes.

The probes attached to the magnetic beads can be nucleic acids (e.g., oligonucleotides), proteins, polypeptides, aptamers, carbohydrates, glycoproteins, glycolipids, or small molecules. The target molecule can be a nucleic acid, a protein, a polypeptide, an aptamer, a carbohydrate, a glycoprotein, a glycolipid or a small molecule. The target molecule can be labeled with a detectable particle (e.g., a gold nanoparticle or a charged-particle), a dye molecule, or a biomolecule (e.g., an antibody or biotin) that can be detected subsequently by other assays such as ELISA.

In another aspect, this invention features a kit for performing the just-described in-solution microarray assay. This kit includes a multi-well plate and magnetic beads placed in the wells, each of which contains one or more magnetic beads. Different probes are attached to the magnetic beads, with the probes attached to each bead being identical. Further, the beads in each individual well are coated with identical probes.

In still another aspect, this invention features a system for performing the method described above. This system includes a plate containing (1) a number of wells, which may or may not contain magnetic beads, and (2) a magnet underneath the plate. The magnetic force generated by the magnet, e.g., permanent or electronic, is readily removable. In one example, the wells in the plate contain magnetic beads on which different probes are attached and each well contains one or more magnetic beads on which identical probes are attached.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1a is a perspective view of a kit for performing an in-solution microarray assay. This kit contains a plate having a plurality of wells and is accompanied by a magnet underneath it.

FIG. 1b is a schematic diagram illustrating that each well shown in FIG. 1a contains magnetic beads to which probes are attached.

FIG. 2 is a schematic diagram showing a method of performing an in-solution microarray assay.

### DETAILED DESCRIPTION

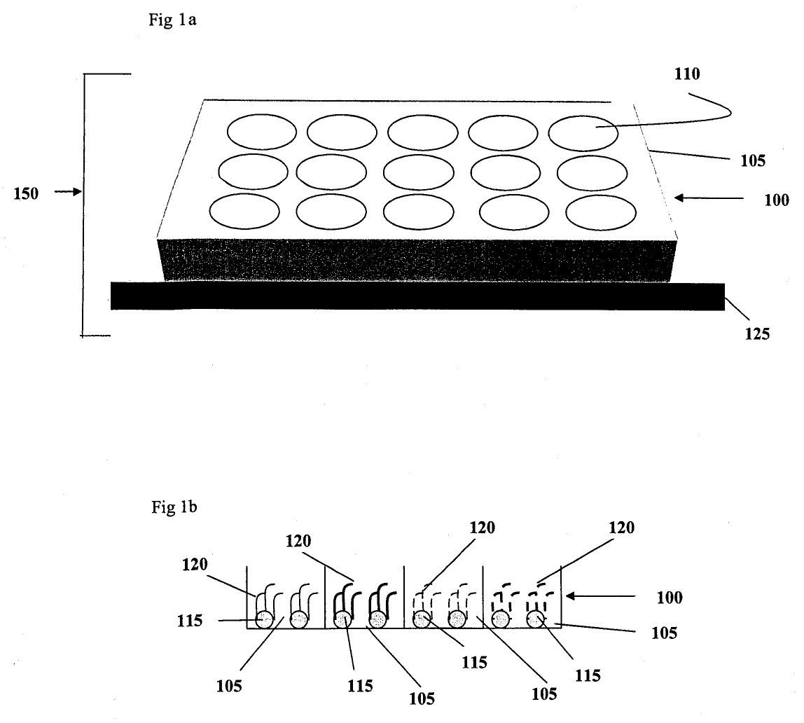

FIG. 1a shows a kit of the invention. This kit 100 includes a plate 105 having a plurality of wells 110, in all or a portion of which a plurality of magnetic beads 115 are placed. See FIG. 1b. The beads in different wells 110 are coated with different probes 120, while the beads in the same well are coated with identical probes. The probes can be attached to the beads by methods well known in the art. In one example, the surfaces of the beads is modified with amino groups activated by 3-maleimidobenzoic acid N-hydroxysuccinimide ester and thiolated DNA probes are then be attached to the modified beads via reaction with the activated amino groups.

FIG. 1a also shows a system of this invention. This system 150 can include the above-described kit 100 and a magnet 125 underneath it. The magnet generates a magnetic force strong enough to immobilize a magnetic bead. The magnetic force is readily removable. If a permanent magnet is used, the magnetic force can be removed by physically taking the magnet away from the kit. If an electromagnet is used, the magnetic force can be conveniently removed by switching off the magnetic field generating the force. Alternatively, this system can include the above described kit except that no magnetic beads are placed in the wells.

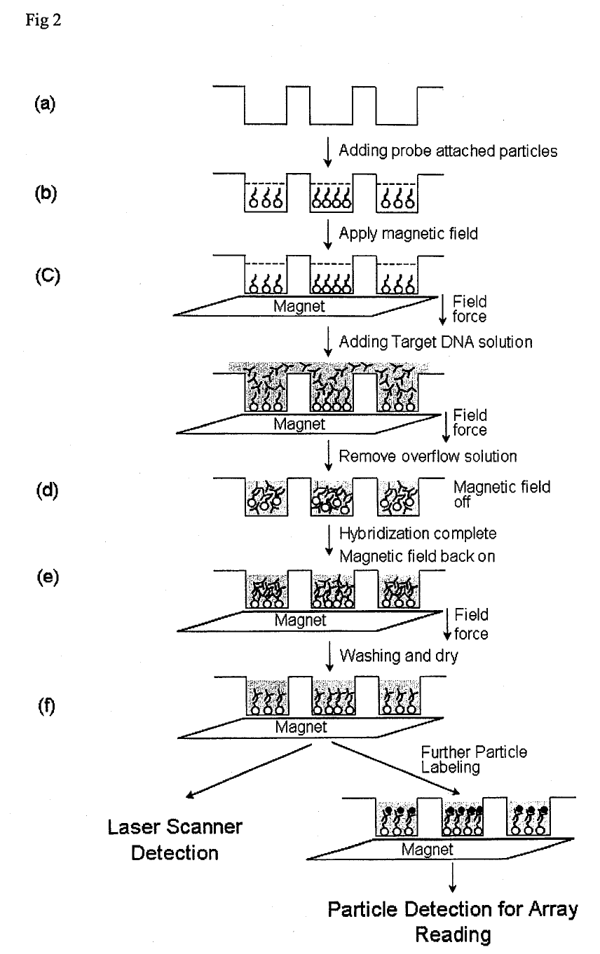

FIG. 2 illustrates an embodiment of the in-solution microarray assay of this invention. This assay is carried out in the multiple wells of a plate. See FIG. 2(a). The diameter of the wells can range from 1 micrometer to a few centimeters, depending on the number of binding reactions between probe-target molecule to be carried out in the assay. The depth of the wells can range from a few microns to a few centimeters depending on the volume of the solution needed for the binding reactions. It might be desired to use a minimal volume of the solution in each well to save cost.

A plurality of magnetic beads coated with different probes are placed in the wells. See FIG. 2(b). The beads in the same well are coated with identical probes. The probes can be nucleic acids, proteins, polypeptides, carbohydrates, glycoproteins, glycolipids aptamers, or small molecules. Aptamers are oligonucleic acids or peptide molecules that bind to a specific target molecule. They can be selected from a large random sequence pool or isolated from natural sources.

Next, a magnetic force is applied to immobilize the magnetic beads, such as Gamma-iron oxide beads or cobalt beads, onto the bottoms of the wells. See FIG. 2(c). The strength of the magnetic force to be applied relies on the type of the beads and the binding solution used in a particular assay. It can be pre-determined using magnetic beads coated with dye molecules.

Then, a sample suspected of containing one or more target molecules is mixed or dissolved in a binding solution. This solution must be conducive to the binding between the probes and the target molecules. After adding the binding solution containing the sample into each well, any overflow of the solution is removed. The solution level in each well must be lower than the edge of the well so that magnetic beads in different wells are not mixed when the magnetic force is removed.

After the magnetic force is removed to suspend the magnetic beads, the binding reactions between the probes and the target molecules are carried out in the solution. See FIG. 2(d). The plate can be gently shaken under a designated temperature to facilitate the binding between the probes and the target molecules. This binding temperature can be determined based on various factors, e.g., the probe to be used and the target molecules to be detected, the affinity between the probe and the target, or the desired stringency conditions. When the binding reactions are complete, the magnetic force is re-applied to re-immobilize magnetic beads down to the bottoms of the wells. Target molecules that bind to the probes are also thus immobilized. See FIG. 2(e).

After washing away free target molecules from all of the wells, the presence of any immobilized target molecule in a well is determined. See FIG. 2(f). One detection method is to label the target molecules with a detectable substance, such as a particle (e.g. a gold particle), a dye molecule (e.g., Cy3 or Cy5), or a biomolecule (e.g., antibody or biotin) that can be detected subsequently by assays such as ELISA. The presence of the detectable substance in a well indicates that a target molecule is present. Various methods known in the art can be used to detect the presence of the above-mentioned detectable substances. For example, a laser scanner can be used to detect a dye molecule that produces laser-induced fluorescence. A PC scanner or a digital camera can detect gold particles (e.g., micro or nano) with or without silver staining. When a biomolecule is used to label target molecules, the biomolecule can be detected after binding to a detectable second molecule that can bind to it specifically. For example, if biotin is used to label a target biomolecule, streptavidin attached to a gold particle can be used to detect the presence of the immobilized target molecule by binding to the biotin attached to it.

The specific examples below are to be construed as merely illustrative, and not limitative of the remainder of the disclosure in any way whatsoever. Without further elaboration, it is believed that one skilled in the art can, based on the description herein, utilize the present invention to its fullest extent. All publications cited herein are hereby incorporated by reference in their entirety.

### EXAMPLE 1

### In-Solution Hybridization Between Oligonucleotides Attached to Magnetic Beads and Beacon DNAs

Oligonucleotides (thiolated) having the sequences of

| | |
|---|---|
| (1) | |
| 5′-SH-AAAAAAAAAACATAGGTCTTAACTT-3′, | (SEQ ID NO: 1) |
| (2) | |
| 5′-SH-AAAAAAAAAACATAGGTGTTAACTT-3′, | (SEQ ID NO: 2) |
| (3) | |
| 5′-SH-AAAAAAAAAACATCGGTCTTAACTT-3′, | (SEQ ID NO: 3) |
| and | |
| (4) | |
| 5′-SH-AAAAAAAAAAAGGTAACTTCATTCT-3′ | (SEQ ID NO: 4) |

were bound to 10-nm magnetic iron nanoparticles, about 15 oligonucleotide molecules being attached to each nanoparticle [particle-oligo(1), particle-oligo(2), particle-oligo(3), and particle-oligo(4)]. Oligonucleotides (1), (2) and (3) differ from each other by one nucleotide (indicated in boldface). Oligonucleotide (4) includes multiple nucleotide variations compared to the other oligonucleotides.

The surfaces of the magnetic nanoparticles were modified with amino groups activated by 3-maleimidobenzoic acid N-hydroxysuccinimide ester. The thiolated oligonucleotides were then attached to the modified particles by reacting with the activated amino groups.

The sequence of molecular beacon 1 is FAM-5′ GCGAGAAGTTAAGACCT ATGCTCGC-3′-DABCYL (SEQ ID NO:5). FAM is a fluorescence dye and DABCYL is a quencher. Molecular beacon 1 includes a sequence complementary to oligonucleotide (1).

The sequence of molecular beacon 2 is FAM-5′ GCGAGAAGTTAACACCT ATGCTCGC-3′-DABCYL (SEQ ID NO:6).

The magnetic nanoparticles, on which the above oligonucleotides were attached, were placed into the micro-wells in a plate. Each well contained one or more magnetic nanoparticles on which identical oligonucleotides were attached. An electromagnetic force was applied so that all magnetic nanoparticles were immobilized onto the bottoms of the wells. Then, a solution containing molecular beacon 1 or molecular beacon 2, both labeled with FAM and DABCYL, was added to each of the wells. The solution, containing 100 mM Tris-HCL (pH 8) and 1 mM MgCl₂, is conducive to nucleic acid hybridization. After removing any overflowed solution, the magnetic field of the electronmagnet was switched off to suspend the magnetic nanoparticles in the solution. The oligonucleotides attached to the magnetic nanoparticles then hybridized to molecular beacons in the solution. The experimental conditions for the hybridization was: 125 pmol beacon and 25 pmol target nucleotide dissolved in 155 ul 100 mM Tris-HCl (pH 8) containing 1 mM MgCl₂. Next, the magnetic force was re-applied to re-immobilize the magnetic nanoparticles onto the bottoms of the wells. The wells were then washed to remove any molecular beacons that were not hybridized to the oligonucleotides attached to the magnetic nanoparticles. Finally, fluorescence signals in each individual well were detected and recorded. The molecular beacons were excited at 494 nm and the fluorescence signals were measured at 518 nm.

Free oligonucleotide (1) were used as a control in this example. Each hybridization assay was repeated six times.

The hybridization reaction between particle-oligo(1) and molecular beacon 1 was completed (>90%) within 30 minutes. This hybridization rate is similar to that of the hybridization reaction between free oligonucleotide (1) and molecular beacon 1. Typically, it takes more than 10 hours to complete a conventional on-surface microarray hybridization reaction, i.e., nucleic acids hybridizing with probe oligonucleotides immobilized on the surface of a chip. Thus, this method increases the hybridization rate by at least 20 folds compared to a conventional microarray hybridization assay. In other words, it significantly reduces the time required to complete such an assay.

Results from this example also demonstrate that this method is highly specific. First, particle-oligo(1) hybridized poorly to molecular beacon 2, whose sequence has no homology to that of oligonucleotide(1). Second, while particle-oligo(1) hybridized to molecular beacon 1 with high efficiency, particle-oligo(2), particle-oligo(3), and particle-oligo(4) failed to hybridize to molecular beacon 1. Note that oligonucleotide(2) and oligonucleotide(3) differ from oligonucleotide(1) by only one nucleotide. These results clearly indicate that this method is highly efficient in recognizing single nucleotide polymorphisms (SNP).

This method is also highly reproducible. All hybridization reactions in this example were repeated six times and similar results were obtained in all duplicate reactions.

### EXAMPLE 2

### Performing the In-Solution Microarray DNA Hybridization to Study Gene Expression and SNP

Oligonucleotides are immobilized onto magnetic nanoparticles, whose size is less than 150 nm. These magnetic nanoparticles are suspended in a solution conducive to DNA hybridization and placed in the micro-wells in a plate, underneath which is an electromagnet. The total volume of the solution placed in each well ranges from a few nanoliters to a few microliters. The magnetic nanoparticles are immobilized onto the bottoms of the wells by turning on the magnetic field of the electromagnet.

Messager RNAs are extracted from cells and target cDNAs are prepared by RT-PCR using these mRNAs as templates. These cDNAs are labeled with Cy3 by methods known in the art and are dissolved in the above-described solution. Then the solution containing the target cDNAs are added into each well. After removing any overflowed solution, the magnetic field is switched off to allow the magnetic nanoparticles to suspend in the solution so that the binding between the oligonucleotides and the target cDNAs can be carried out in the solution. The same hybridization conditions described in Example 1 are used here.

After the hybridization reaction is complete, the magnetic field is turned on again to re-immobilize the nanoparticles onto the bottoms of the wells. Target cDNAs that are not hybridized to the oligonucleotides are washed away from each well. Then the signal of Cy3 in each well is detected by means known in the art. A well displaying the signal indicates that a target cDNA is hybridized to the oligonucleotide attached to the magnetic nanoparticles in that well. Based on the sequence of this oligonucleotide, one will know which gene is expressed in the cells.

The above-described method is also used to study SNPs. In that case, the target DNAs are obtained by PCR amplification of the SNP loci being studied. All of the other procedures are the same as described above.

### EXAMPLE 3

### In-Solution Microarray Assay in which Target DNAs are Labeled with Particles

The steps of carrying out this in-solution microarray assay are the same as described in Examples 1 and 2, except that the target DNA molecules are labeled with gold particles. The signal of gold particles can be amplified by silver-staining. The amplified signal then can be detected by a PC scanner. See Taton, et al., Science, 289:1757 (2000) and Alexandre et al., Analytical Biochemistry, 295:1-8 (2001). A well displaying the signal indicates that a target DNA is hybridized to the oligonucleotide attached to the magnetic nanoparticles placed in that well.

Alternatively, the target DNAs are labeled with biotin. These target DNAs are detected by further labeling with gold particles coated with streptavidin. The signal of gold particles are detected by the just-described method.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

What is claimed is:

1. A kit for performing a microarray assay, comprising:
a plate containing a plurality of wells, and
a plurality of magnetic beads on which different probes are attached, probes attached to each magnetic bead being identical,
wherein the plurality of magnetic beads are placed in the plurality of wells and each well contains one or more magnetic beads on which identical probes are attached.

2. The kit of claim 1, wherein the probes attached to the magnetic beads are nucleic acids, proteins, polypeptides, aptamers, carbohydrates, glycoproteins, glycolipids, or small molecules.

3. The kit of claim 1, wherein the probes attached to the magnetic beads are nucleic acids.

4. The kit of claim 3, wherein the nucleic acids are oligonucleotides.

5. A system for performing a microarray assay, the system comprising:
a plate containing a plurality of wells, and
a magnet underneath the plate, wherein the magnet generates a magnetic force that is readily removable.

6. The system of claim 5, further comprising a plurality of magnetic beads on which different probes are attached, probes attached to each magnetic bead being identical, wherein the plurality of magnetic beads are placed in the plurality of wells and each well contains one or more magnetic beads on which identical probes are attached.

7. The system of claim 5, wherein the magnet is a permanent magnet or an electronic magnet.

8. The system of claim 6, wherein the probes attached to the magnetic beads are nucleic acids, proteins, polypeptides, aptamers, carbohydrates, glycoproteins, glycolipids, or small molecules.

9. The system of claim 8, wherein the probes are nucleic acids.

10. The system of claim 9, wherein the nucleic acids are oligonucletides.

11. A method for performing a microarray assay, the method comprising:
providing a plate having a plurality of wells,
dispersing in the wells a plurality of magnetic beads on which different probes are attached, wherein each well contains one or more magnetic beads to which identical probes are attached,
applying a magnetic force to immobilize the magnetic beads onto the bottoms of the wells;
adding to the wells a solution suspected of containing one or more target molecules,
removing the magnetic force to allow the target molecules, if any, to interact with the probes in the solution,
re-applying the magnetic force to re-immobilize the magnetic beads onto the bottoms of the wells,
washing the wells to remove free molecules, and
detecting a signal in any of the wells, said signal indicating binding of one of the target molecules to one of the probes.

12. The method of claim 11, wherein the probes attached to the magnetic beads are nucleic acids, proteins, polypeptides, aptamers, carbohydrates, glycoproteins, glycolipids, or small molecules.

13. The method of claim 12, wherein the probes are oligonucleotides.

14. The method of claim 11, wherein the target molecule is a nucleic acid, a protein, a polypeptide, an aptamer, a carbohydrate, or a small molecule.

15. The method of claim 11, wherein the target molecule is linked to a detectable substance.

16. The method of claim 15, wherein the detectable substance is a charged particle.

17. The method of claim 16, wherein the charged particle is a gold nanoparticle.

18. The method of claim 15, wherein the detectable substance is a dye.

19. The method of claim 15, wherein the detectable substance is a biomolecule.


SEQUENCE LISTING (6 sequences)

SEQ ID NO: 1 - DNA, 25 bp, Artificial Sequence
  Description of Artificial Sequence Synthetic oligonucleotide
aaaaaaaaaacataggtcttaactt

SEQ ID NO: 2 - DNA, 25 bp, Artificial Sequence
  Description of Artificial Sequence Synthetic oligonucleotide
aaaaaaaaaacataggtgttaactt

SEQ ID NO: 3 - DNA, 25 bp, Artificial Sequence
  Description of Artificial Sequence Synthetic oligonucleotide
aaaaaaaaaacatcggtcttaactt

SEQ ID NO: 4 - DNA, 25 bp, Artificial Sequence
  Description of Artificial Sequence Synthetic oligonucleotide
aaaaaaaaaaaggtaacttcattct

SEQ ID NO: 5 - DNA, 25 bp, Artificial Sequence
  Description of Artificial Sequence Synthetic oligonucleotide
gcgagaagttaagacctatgctcgc

SEQ ID NO: 6 - DNA, 25 bp, Artificial Sequence
  Description of Artificial Sequence Synthetic oligonucleotide
gcgagaagttaacacctatgctcgc